(19) United States
(12) Patent Application Publication
(10) Pub. No.: US 2005/0198188 A1
(43) Pub. Date: Sep. 8, 2005

(54) Automatic discovering of web services

(76) Inventor: Andrew James Hickman, London (GB)

Correspondence Address: PHILIPS INTELLECTUAL PROPERTY & STANDARDS, P.O. BOX 3001, BRIARCLIFF MANOR, NY, 10510, US

(21) Appl. No.: 10/507,199

(22) PCT Filed: Mar. 12, 2003
(86) PCT No.: PCT/IB03/00943

§ 371 Date: Sep. 9, 2004

(30) Foreign Application Priority Data
Mar. 14, 2002 (GB) 0205974.9
May 23, 2002 (GB) 0211900.6
Nov. 21, 2002 (GB) 0227200.3

(51) Int. Cl. G06F 15/16

(52) U.S. Cl. 709/217; 709/203

(57) ABSTRACT

A method for automatically discovering web services comprises querying a known UDDI server address containing a list of web services, identifying from the list suitable web services, and automatically downloading at least one machine readable description of a web service. Apparatus for automatically discovering web services is also described, which comprises communicating means for querying a known UDDI server address containing a list of web services and identifying from the list suitable web services, the communicating means arranged to automatically download at least one machine readable description of a web service.

This invention relates to a method for automatically discovering web services from a networked CE (consumer electronics) device using UDDI (Universal Description, Discovery and Integration). This invention also relates to the enhanced discovery of TV Anytime web services using UDDI taxonomies.

The term “web service” refers to the use of an Internet server to provide useful functionality or data to a remote client. By utilising standard protocols (often SOAP, XML and HTTP) it is possible for a large range of devices (PCs, PDAs, mobile phones, etc.) to utilise these services. More importantly, these protocols allow software to automatically exploit the service without the need for human interaction, unlike a web site. Some web services are particularly useful to consumer electronics devices, for example, a grocery shopping web service that allows a device to order items automatically could be used by a networked fridge. Equally, a music web service that provides enhanced information on artists, recordings and concerts would be useful to a CD or MP3 player. Likewise, a Personal Digital Recorder (PDR) or Integrated Digital TV could access a web service that provides data on television programmes.

Currently, for more capable networked devices (PCs, PDAs) a number of user driven methods exist for finding new web services. For example, the user can manually enter the URL of the service they require into the CE device. This is inconvenient, error prone and tends to favour the technically minded user. It also requires the device to have a means of text input. Alternatively, a search engine can be used to find suitable web services. This requires all services to be able to indicate compliance to a certain web service interface, and therefore requires the search engine to be modified in such a way that it can identify this compliance. It also requires a protocol to be defined for allowing the device to retrieve the found services from the search engine. A relatively complicated user interface is needed on the device itself. Thirdly, the device may have its software or data cache upgraded over the network. Such a solution requires the manufacturer or some third party to provide a service for tracking new compliant web services and then sending the new software to the device. Such upgrades are not always feasible in a cheap embedded device.

It is an object of the invention to improve upon the known methods of discovering web services. It can be seen that this invention is particularly useful in lightweight CE devices that will often not be able to use any of the above three solutions.

Consider a CE device, which is able to use one or more web services to provide enhanced functionality and data to the user. It will be necessary for all the web services that the device uses to have a well-defined interface, which is supported and understood by the client device. At the point of sale the device will be pre-programmed with the location (i.e. URL) of a number of these services, which the device makes use of both automatically and as a result of user interaction. After this time it is likely that other businesses will provide new and enhanced, yet technically compatible, web services. The device has no systematic way of discovering these services and offering them to the user.

Up until now web based services have been predominantly HTML based and user driven. Standards to allow computer programs to communicate without user intervention have existed for a long time (e.g. Distributed COM) but these have not been suitable for small devices. It is only with the advent of IP/HTTP and the recent development of XML that the use of completely platform independent web services, which can be realistically used by lightweight CE devices has become feasible. Addressing the issue of discovering such services in a non-proprietary fashion is even more recent and has been the goal of the Universal Description, Discovery and Integration project. However, this work has been targeted at e-commerce and business-to-business transactions. The specific needs of CE devices have not been considered.

According to a first aspect of the present invention, there is provided a method for automatically discovering web services comprising querying a known UDDI server address containing a list of web services, identifying from said list suitable web services, and automatically downloading at least one machine readable description of a web service.

According to a second aspect of the present invention, there is provided apparatus for automatically discovering web services comprising communicating means for querying a known UDDI server address containing a list of web services and identifying from said list suitable web services, said communicating means arranged to automatically download at least one machine readable description of a web service.

The main advantage of such an approach is that it doesn't require user browsing or keyboard input. This makes it particularly appropriate for lightweight embedded CE devices that will generally not have technical users.

The suitable web services are those that the querying device can use to enhance its functionality. The identifying stage is based upon the structure of the defining protocol that categorises the web services. In this way all devices can use the same methodology for obtaining web services, with only those appropriate to the requesting device being returned. Web services can be easily added and devices already installed can periodically query the address to obtain new services.

Advantageously, if the web services being sought are TV Anytime web services, then the querying contains a specific request, limiting the type of TV Anytime web service identified. In this way a TV Anytime device such as a PDR can make a search for suitable web services that is limited to a particular type of service.

This invention proposes a method for how such devices can automatically find new and compatible services, as they become available. The novel aspect is that it does this in a fully automatic fashion, which requires no intervention from the user. In this way, the device is able to offer the user a greater choice of services as they become available after the user bought the device. For example, in the case of a fridge, if a new store opened nearby which provides a grocery ordering web service, it would be possible for the device to alert the user of this fact, and also to be sure of the technical compliance of that service.

Embodiments of the invention will now be described, by way of example only, with reference to the accompanying drawings, in which:

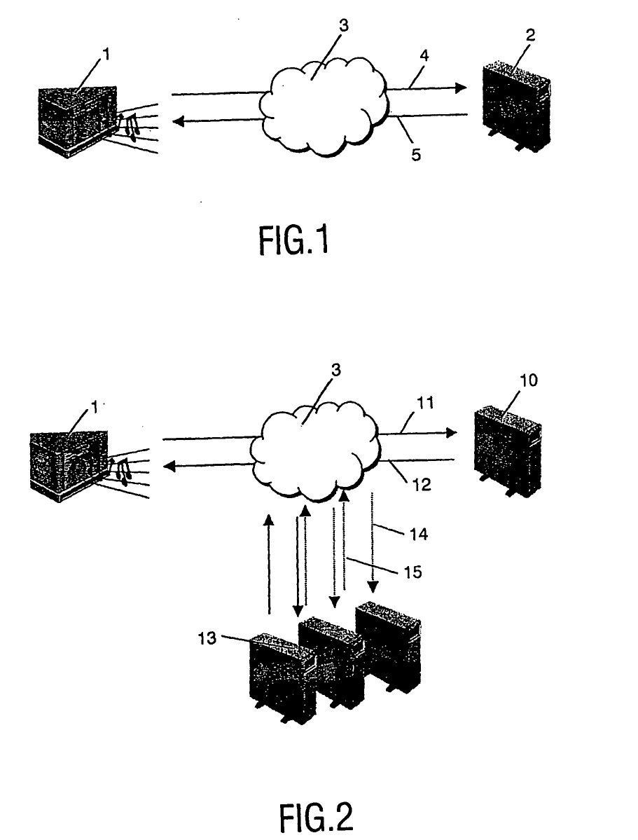

FIG. 1 is a schematic diagram of a conventional operation of a network-enabled, embedded device,

FIG. 2 is a schematic diagram of an enhanced operation of a network-enabled, embedded device, as an example of the invention,

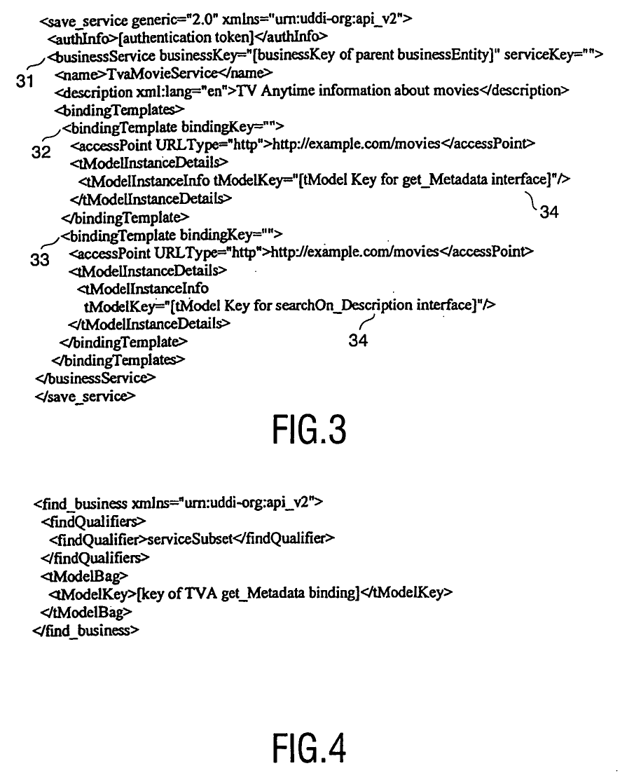

FIG. 3 is an example of a UDDI save_service publication API,

FIG. 4 is an example of a UDDI find_business inquiry API,

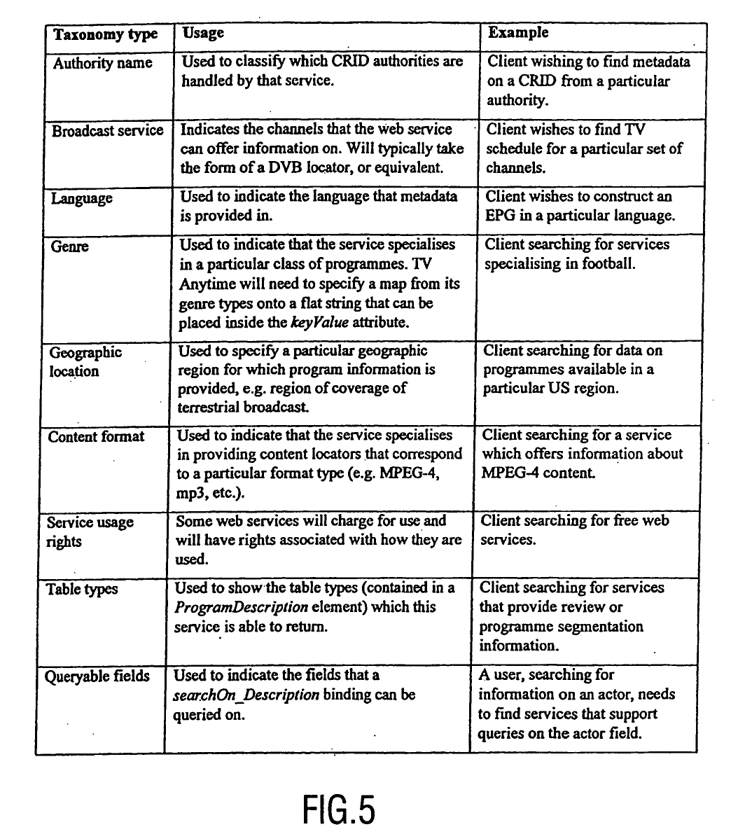

FIG. 5 is a table of taxonomies for categorising TV Anytime services, and

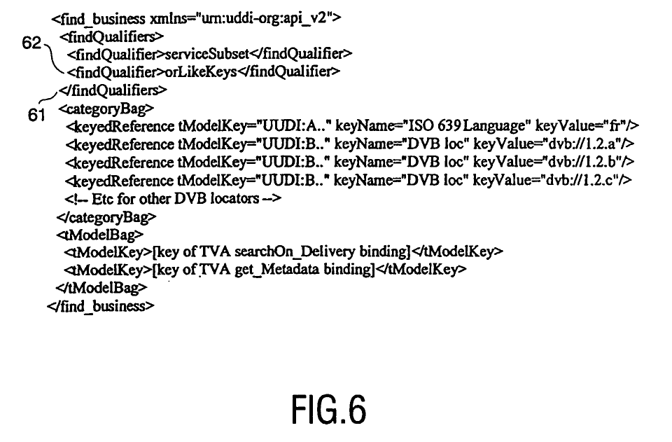

FIG. 6 is an example of a categoryBag element.

FIG. 1 shows a network-enabled, embedded device 1, which is a digital radio operating as a DAB (Digital Audio Broadcast) receiver. The receiver 1 is connected to a remote network server 2 via a wide area network such as the Internet 3. The remote server 2 offers a web service that is of interest to the receiver 1, such as track listings, information on artists, etc. To obtain the service, the receiver 1 sends a structured query 4 (such as a SOAP request for information on a particular song) via the Internet 3 to the server 2. The server 2 replies with a structured response 5 (such as a SOAP response containing the information on the particular song.

FIG. 2 shows the enhanced operation of the network-enabled, embedded device 1. The DAB receiver 1 sends a structured UDDI query 11 to a UDDI server 10, the server being available at a well-known URL. The query 11 would be a request for web services that are technically compliant with the server 2 and could be, for example, a request for web services that offer information for radio broadcasts within the UK. The UDDI server 10 will return a structured UDDI response 12 to the receiver 1, such as a response containing the information on those services that satisfy the criteria of the query 11. Servers 13 contain one or more newfound web services. These web services are distinct, may have been set up after the receiver 1 was sold, and are all technically compliant with the server 2 (i.e. they can be successfully used by the receiver 1). The receiver 1 can discover these services via a structured query 14 and receive a structured response 15.

As described above, the method carried out by the receiver 1 for automatically discovering web services comprises querying a known UDDI server address containing a list of web services, identifying from the list suitable web services, and automatically downloading at least one machine readable description of a web service. The querying comprises transmitting a query in a predefined format, and the query can contain a specific request, limiting the type of web service identified. Following receipt of the structured query, the server 1 can respond to the querying with a response comprising the list of suitable web services, and the receiver can select a web service from the list and communicate the selected web service to the UDDI server address. The server 2 can then supply the selected web service.

The receiver apparatus 1 for automatically discovering web services comprises communicating means for querying the known UDDI server address containing a list of web services and identifying from the list suitable web services, the communicating means arranged to automatically download at least one machine readable description of a web service. The receiver 1 includes a user interface for displaying information and for receiving user instructions. The user interface is arranged to display the list of suitable web services and to receive a user selection of one or more of the displayed services.

UDDI makes available structured information on registered web services via a well-defined interface, in a well-known location. When a service provider (i.e. a shop or a TV schedule listing provider) offers a new service they publish the details on a UDDI node and register it as being compliant with a particular web service standard (such as TV Anytime for TV schedules). This standard will have a unique identity (tModel) in the UDDI registry. When a CE device then queries the UDDI node it uses this unique identity to find compliant services. It is further proposed that the device can exploit other registered categorisation taxonomies to refine the search for services. For example, ISO 3166 is a global geographic classification taxonomy that a device could use to make sure that a shopping service was being offered by a shop in reasonable geographic proximity. Alternatively, by registering a genre taxonomy it would be possible to search for TV Anytime web services that specialise in movie information, say.

In order for devices to be able to take advantage of web services via this simple methodology, the following steps are required:

1. A standards body (or similar initiative) standardises a web service interface suitable for a class of CE devices.

2. This service is registered with a UDDI node and is assigned a UUID (universally unique identifier) for that standard interface (using the UDDI save_tModel API).

3. Service providers produce implementations of this standard interface. They register the new service using the save_service API, assuming that the business itself has already been registered with UDDI. The enclosed bindingTemplate will contain a reference to the UUID of the tModel registered in step 2. At this stage they may also assign further standardised categorisations to their service (e.g. a retail service registers that it is based in London and offers pet food.). The categorisations are added using the categoryBag sub-element of the businessService element.

4. A CE device is designed which is able to use the standardised web interface.

5. After being sold, the device queries a UDDI node to find services that support this interface. To do this the find_business API is used containing just a tModelBag argument with a reference to the required tModel. A list of services is returned to the device, which can then be further refined automatically (based on machine-readable service descriptions) or by the user (based on brand preferences, recommendations, etc.).

6. Depending on the service type it is possible that the device can target its service discovery in an improved fashion. E.g. only find shops that are nearby, only find TV listing services for channels that the set top box is capable of showing, etc.

This defines a mechanism by which CE devices can use UDDI to discover web services. As new service providers come into existence and new services are offered, these can be added as per step 3 above, and all devices that have already been sold can access these services.

The above mechanism can be used by devices such as digital television receivers to discover TV Anytime web services. By assigning taxonomies to implementations of these web services it is possible to provide a better means of finding a useful service. A number of problems arise when trying to discover TV Anytime web services that fulfil a particular purpose (such as a service that specialises in movie information, or a service that offers information on programmes available in the local area). Described below in detail is a proposal for the taxonomies that should be assigned to TV Anytime web services and how a TV Anytime device can exploit UDDI to greatly improve the way in which web services are discovered.

It is necessary to consider how UDDI will be used to discover TV Anytime web services. Firstly, registering of the TV Anytime services interface specification must be carried out. The TV Anytime Forum must first register its web service interfaces with a UDDI node registry. A tModel will be published for each of the TV Anytime web service types. For this purpose, the UDDI save_tModel publication API is used. The registry will assign a unique tModelKey to the tModel and this key will act as a global identifier for that web service protocol. Secondly, a web site offering TV Anytime services (i.e. a broadcaster or third party metadata provider) will publish to a UDDI node the details of their services. They register the new service using the UDDI save_service publication API (assuming that the parent businessEntity itself has already been registered with UDDI). Such a UDDI save_service publication API is shown in FIG. 3.

In FIG. 3, a businessService 31 is created for each TV Anytime service that needs to be registered. Each businessService element contains a bindingTemplate for each of the bindings offered by that service (e.g. get_Metadata 32 and searchOn_Description 33). The enclosed bindingTemplates will contain a reference to the appropriate tModelKey 34 created by the TV Anytime Forum in the previous stage. In this way, the tModel behaves as a technical fingerprint that formally indicates the TV Anytime compliance of the service.

When discovering services from a PDR (Personal Digital Recorder), a TV Anytime device (with return channel) will be able to understand one or more of the different TV Anytime service types. The device can query a UDDI node to find services that offer this interface. As an example, consider a TV Anytime device trying to find a get_Metadata service. This can be done with UDDI by using the find_business inquiry API as shown in FIG. 4. This will succeed in returning a list of TV Anytime services that offer a get_Metadata binding. The TV Anytime device can then use further UDDI queries to obtain more information—such as the name and description—about those services. The problem is that this search lacks focus: there may exist hundreds of TV Anytime get_Metadata services and only some of them will be useful. In reality, the TV Anytime device wishes to discover TV Anytime devices that provide a specific service. For example, the device may wish to find a service that can offer schedule listings for BBC programmes, or a service that returns critics' reviews with the metadata it provides. This invention describes a method that makes such types of discovery possible.

It is proposed to standardise a set of taxonomies that can be used to categorise TV Anytime services. These taxonomies may be publicly defined, or defined by the TV Anytime Forum. When a service provider chooses to offer a TV Anytime service it uses the taxonomies to specify the nature of the service being offered. A TV Anytime device searching for a specific service can include the taxonomies in the search criteria, and in this way create a much more focused query. The taxonomies of FIG. 5 are useful for categorising TV Anytime services.

There are many scenarios when use of taxonomies will greatly enhance the way in which TV Anytime web services can be exploited. To illustrate this, consider the example of a newly purchased DVB (Digital Video Broadcast) set-top-box trying to create an enhanced EPG (Electronic Programme Guide) based on TV Anytime data downloaded over the return channel. The set-top-box wishes the EPG to be in French (established from a user preference, say), and to display information on a known set of DVB locators (obtained from DVB-service information). To enable the construction of an EPG, the service will need to offer a searchOn_Delivery and get_Metadata binding. The following sections describe the additional steps to those outlined above, and illustrate how the use of taxonomies enable the discovery of services required by this scenario.

TV Anytime will additionally need to register unchecked category-type tModels for the taxonomies it chooses to standardise (see http://www.uddi.org/pubs/TN-taxonomy-provider-V1.00-Final-20010717.pdf). This will result in each taxonomy having a unique tModelKey. The specification of each taxonomy will define the allowable values that the taxonomy can take (e.g. a genre taxonomy might be an enumeration of strings), and the semantics associated with those values. Note that it is also possible for parties to register and use new taxonomies not standardised by TV Anytime. Standard TV Anytime device will not be able to exploit such taxonomies, but proprietary implementations will be able to.

For publishing details of a Service Implementation, the method of publication will be the same as that described in the section above with reference to FIG. 3. In addition, the message will include a categoryBag element containing the taxonomies that the service provider chooses to assign to that service. For the above scenario, a matching service will have assigned itself a language taxonomy of French, and at least one DVB locator taxonomy corresponding to a DVB service available to that set-top-box.

There are no limits on the number of taxonomies that can be assigned to a service and it is possible to assign a service more than one value of the same taxonomy type (i.e. there can be multiple keyedReference elements with the same tModelKey attribute value).

When discovering services from a PDR, to restrict the search, a categoryBag element is included in the search for services, an example of which is shown in FIG. 6. The categoryBag element 61 specifies a set of taxonomies that the matching service must conform to. In this case, the matching service must provide metadata in French and must offer scheduling information on the indicated DVB channels. This search qualifier 62 has the effect that the DVB locators are treated in an OR fashion. In other words, a service only has to match one of the DVB locators to return a match. This prevents the set-top-box from needing to make multiple searches each containing a keyedReference with a single DVB locator.

In general the invention could be exploited by any network enabled CE device, which makes use of a web-service that is based on an open standard. Some obvious examples have already been given. Other uses include, for example, a Digital Audio Broadcast receiver obtaining improved programme listings, an oven or microwave exploiting a standard “recipe finder” web service and, in fact, any device could use a web service to indicate that it has a fault or requires servicing and needs to call out a technician.

1. A method for automatically discovering web services comprising querying a known UDDI server address containing a list of web services, identifying from said list suitable web services, and automatically downloading at least one machine readable description of a web service.

2. A method according to claim 1, said method being carried out periodically by a CE device, without user interaction.

3. A method according to claim 1 or 2, wherein said querying comprises transmitting a query in a predefined format, and said query contains a specific request, limiting the type of web service identified.

4. A method according to claim 3, wherein said query contains a request for TV Anytime services, said query further including an element specifying a set of taxonomies to which said service must conform.

5. A method according to claim 4, wherein said set of taxonomies is at least one of authority name, broadcast service, genre, content format, service usage rights, table types and queryable fields.

6. A method according to any preceding claim, and further comprising responding to said querying with a response comprising the list of suitable web services.

7. A method according to claim 6, and further comprising selecting a web service from said list and communicating the selected web service to said UDDI server address.

8. Apparatus for automatically discovering web services comprising communicating means for querying a known UDDI server address containing a list of web services and identifying from said list suitable web services, said communicating means arranged to automatically download at least one machine readable description of a web service.

9. Apparatus according to claim 8, said apparatus being a CE device, and said communicating means periodically carrying said querying without user interaction.

10. Apparatus according to claim 8 or 9, wherein said communicating means queries said UDDI server address by transmitting a query in a predefined format and said communicating means is arranged to include in said query a specific request, limiting the type of web service identified.

11. Apparatus according to claim 10, wherein said query contains a request for TV Anytime services, said query further including an element specifying a set of taxonomies to which said service must conform.

12. Apparatus according to claim 11, wherein said set of taxonomies is at least one of authority name, broadcast service, genre, content format, service usage rights, table types and queryable fields.

13. Apparatus according to any one of claims 8 to 12, and further comprising a user interface for displaying information and for receiving user instructions.

14. Apparatus according to claim 13, wherein said user interface is arranged to display the list of suitable web services and to receive a user selection of one or more of the displayed services.

15. A method for automatically discovering TV Anytime web services comprising querying a known server address containing a list of web services, identifying from said list suitable web services, and automatically downloading at least one machine readable description of a web service, said querying comprises transmitting a query in a predefined format, said query further including an element specifying a set of taxonomies to which said service must conform.

16. A method according to claim 15, wherein said set of taxonomies is at least one of authority name, broadcast service, genre, content format, service usage rights, table types and queryable fields.

17. Apparatus for automatically discovering TV Anytime web services comprising communicating means for querying a known server address containing a list of web services and identifying from said list suitable web services, said communicating means arranged to automatically download at least one machine readable description of a web service, said communicating means queries said server address by transmitting a query in a predefined format, said query further including an element specifying a set of taxonomies to which said service must conform.

18. Apparatus according to claim 17, wherein said set of taxonomies is at least one of authority name, broadcast service, genre, content format, service usage rights, table types and queryable fields.
